(19) United States
(12) Patent Application Publication
(10) Pub. No.: US 2005/0071046 A1
(43) Pub. Date: Mar. 31, 2005

(54) Surveillance system and surveillance robot

(76) Inventors: Tomotaka Miyazaki, Kawasaki-shi (JP); Masafumi Tamura, Chofu-shi (JP); Shunichi Kawabata, Ome-shi (JP); Takashi Yoshimi, Fujisawa-shi (JP); Junko Hirokawa, Tokyo (JP); Hideki Ogawa, Yokosuka-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/899,187

(22) Filed: Jul. 26, 2004

(30) Foreign Application Priority Data
Sep. 29, 2003 (JP) 2003-337759

(51) Int. Cl. G06F 19/00

(52) U.S. Cl. 700/245

(57) ABSTRACT

A surveillance system including a stationary unit and a surveillance robot, the stationary unit includes a first camera unit, and the surveillance robot includes a second camera unit; determination unit for determining an imaging range of the first camera unit; and unit for moving the surveillance robot such that the second camera unit images a range in a to-be-monitored range, which excludes the imaging range of the first camera unit.

### CROSS-REFERENCE TO RELATED APPLICATIONS

This application is based upon and claims the benefit of priority from the prior Japanese Patent Application No. 2003-337759, filed Sep. 29, 2003, the entire contents of which are incorporated herein by reference.

### BACKGROUND

1. Field The present invention relates to a surveillance system and a surveillance robot for monitoring conditions within a facility.

2. Description of the Related Art

Surveillance systems using stationary cameras have widely been used.

Jpn. Pat. Appln. KOKAI Publication No. 2002-342851, for instance, discloses a surveillance system that monitors various facilities using a robot with a surveillance camera.

The range of imaging, which can be covered by a single stationary camera, is limited. A plurality of cameras needs to be installed in a case where the range for monitoring is wide, or in a case where an obstacle is present within the range for surveillance. The system using such stationary cameras may lead to an increase in cost.

With the system using a robot, it is possible to monitor a wide range with a single robot. In this case, however, it is not possible to monitor a specified location at all times.

Both of the above systems (i.e. the system using a stationary camera and the system using a robot) may be introduced in parallel. However, since both systems execute surveillance operations independently, the same range may possibly be monitored by the respective systems in an overlapping fashion, and the efficiency in operation deteriorates due to such useless monitoring.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary block diagram showing the configuration of a surveillance system according to a first embodiment of the present invention;

FIG. 2 shows an example of installation of the surveillance system according to the first embodiment;

FIG. 3 is an exemplary perspective view showing the external appearance of a surveillance robot shown in FIG. 1;

FIG. 4 illustrates an exemplary process procedure of an overall control unit in a “patrol” mode in the first embodiment;

FIG. 5 shows an example of an image of the surveillance robot, which is taken by the camera unit shown in FIG. 1;

FIG. 6 illustrates an exemplary process procedure of the overall control unit in an “at-home” mode in the first embodiment;

FIG. 7 is an exemplary block diagram showing the configuration of a surveillance system according to a second embodiment of the present invention;

FIG. 8 illustrates an exemplary process procedure of the overall control unit in a “patrol” mode in the second embodiment; and

FIG. 9 illustrates an exemplary process procedure of the overall control unit in a “patrol” mode in a third embodiment of the invention.

### DETAILED DESCRIPTION

Embodiments of the present invention will now be described with reference to the accompanying drawings. In general, according to first embodiment of the invention, a surveillance system comprises a stationary unit and a surveillance robot. The stationary unit includes a first camera while the surveillance robot includes a second camera and components to determine an imaging range of the first camera and to move the surveillance robot so that the second camera acquires images in a “to-be-monitored” range, which excludes the imaging range of the first camera.

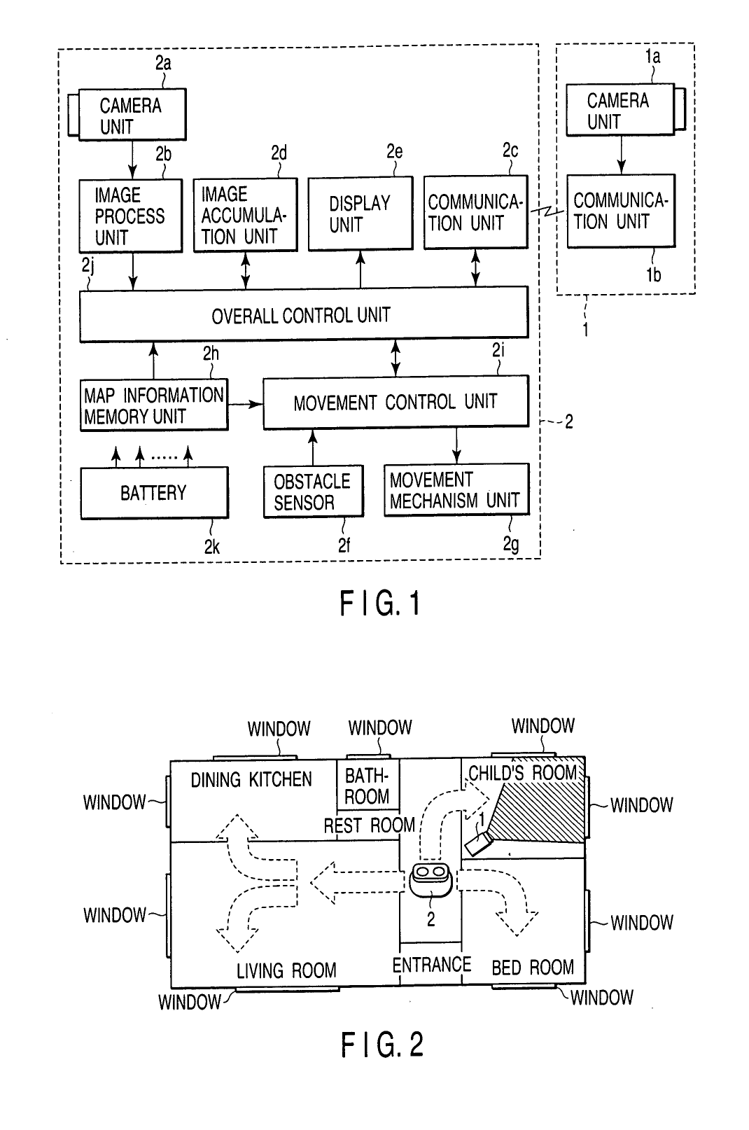

FIG. 1 is an exemplary block diagram showing the configuration of a surveillance system according to a first embodiment of the present invention.

As is shown in FIG. 1, the surveillance system of the first embodiment includes a stationary unit 1 and a surveillance robot 2. The stationary unit 1 is installed at a specified location within a facility to be monitored, where continuous surveillance may be desired. Examples of the facility monitors may include, but are not limited or restricted to a house or particular room such as a child's room in FIG. 2, an office, a public area or establishment, etc. The stationary unit 1 captures images of the conditions at the specified location. On the other hand, the surveillance robot 2 captures images of the conditions within the monitored facility (e.g. a house in FIG. 2) while moving around within the facility.

According to one embodiment, the stationary unit 1 includes a camera unit 1a and a communication unit 1b, as shown in FIG. 1. The camera unit 1a includes one or more cameras, which are adapted to download and/or store captured images. These cameras may include a video camera or a still camera both of which employ imaging devices such as CCDs (Charge-Coupled Devices).

The camera unit 1a is adapted to capture images of conditions surrounding the stationary unit 1. The communication unit 1b conducts wireless communications with the surveillance robot 2. The communication unit 1b transmits images, which are acquired by the camera unit 1a, to the surveillance robot 2.

The surveillance robot 2, as shown in FIG. 1, includes a camera unit 2a, an image process unit 2b, a communication unit 2c, an image accumulation unit 2d, a display unit 2e, an obstacle sensor 2f, a movement mechanism unit 2g, a map information memory unit 2h, a movement control unit 2i, an overall control unit 2j and a battery 2k.

The camera unit 2a includes one or more cameras. These cameras may include any device employing imaging devices (e.g., CCDs) such as a video camera, a still camera or a combination thereof. The camera unit 2a captures images of conditions surrounding the surveillance robot 2. The image process unit 2b processes images that are acquired by the camera unit 2a.

The communication unit 2c establishes wireless communications with the communication unit 1b of the stationary unit 1. This enables the communication unit 2c to receive images from the stationary unit 1.

The image accumulation unit 2d accumulates images that have been processed by the image process unit 2b, and images that are received via the communication unit 2c.

The display unit 2e is adapted to display images that are to be presented to the user. The display unit 2e may also display images that have been processed by the image process unit 2b, images that are received via the communication unit 2c, or images that are accumulated in the image accumulation unit 2d. The display unit 2e may be implemented as a liquid crystal display.

The obstacle sensor 2f detects an obstacle that is present around the surveillance robot 2. The movement mechanism unit 2g includes a motor and transport mechanism (e.g., rotational wheels) that collectively operate to move the surveillance robot 2.

The map information memory unit 2h stores map information that is produced, with consideration given to the room arrangement of the monitored facility.

The movement control unit 2i is adapted to receive an output from the obstacle sensor 2f and map information stored in the map information memory unit 2h. Moreover, movement control unit 2i is further adapted to control the movement mechanism unit 2g so that the surveillance robot 2 can patrol the monitored facility according to a patrol route designated by the overall control unit 2j.

The overall control unit 2j fully controls the respective components of the surveillance robot 2. The overall control unit 2j executes processes, which will be described later, thereby implementing a function for determining the imaging range of the camera unit 1a, a function for determining a patrol route, a function for acquiring an image, which is taken by the camera unit 1a, from the stationary unit 1 through the communication unit 2c, and a function for reproducing and displaying the image accumulated in the image accumulation unit 2d on the display unit 2e.

The battery 2k supplies power to the respective electric circuits that constitute the surveillance robot 2.

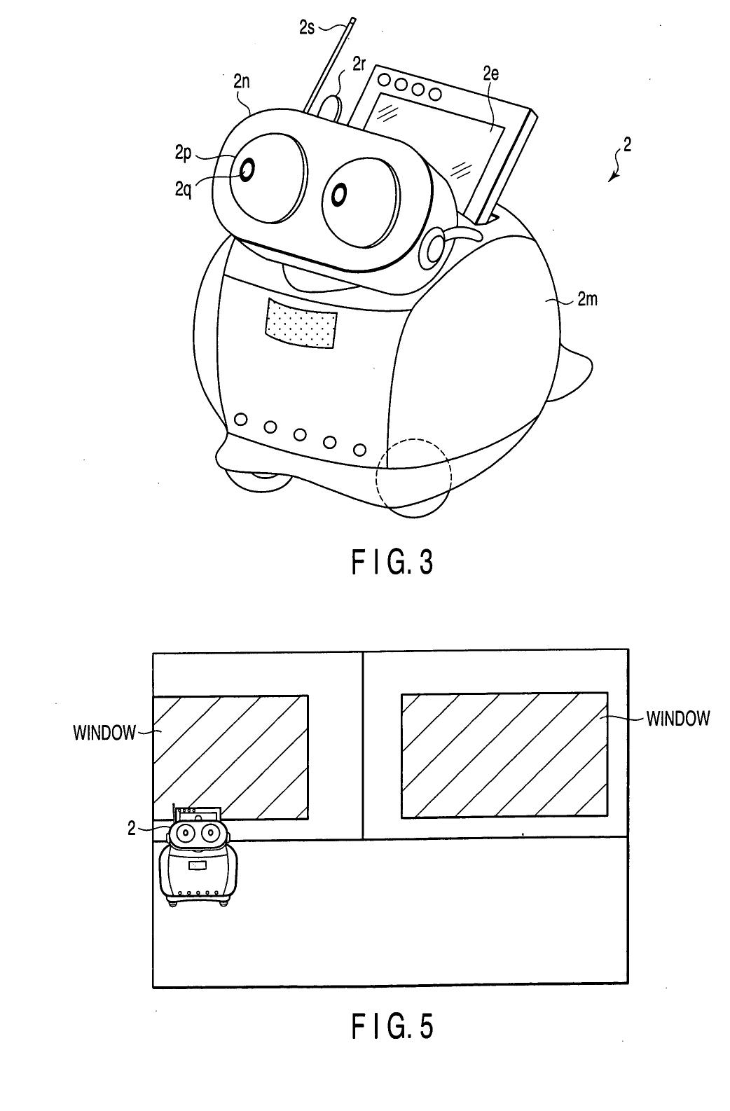

FIG. 3 is an exemplary perspective view showing the external appearance of the surveillance robot 2. In FIG. 3, the parts common to those in FIG. 1 are denoted by like reference numerals, and a detailed description is omitted.

The surveillance robot 2, as shown in FIG. 3, includes a body part 2m and a head part 2n. The body part 2n is provided with eye-like projecting portions 2p. The camera unit 2a is accommodated in the head part 2n and projecting portions 2p. The camera unit 2a effects imaging through windows 2q provided at foremost parts of the projecting portions 2p. A red light 2r is attached on top of the head part 2n to more easily identify which the surveillance robot 2 is located within an area already monitored by camera unit 1a.

An antenna 2s, which is used for wireless communications, projects from the body part 2m. The display unit 2e projects from the body part 2m such that a person can view a display surface thereof.

The operation of the surveillance system with the above-described configuration will now be described.

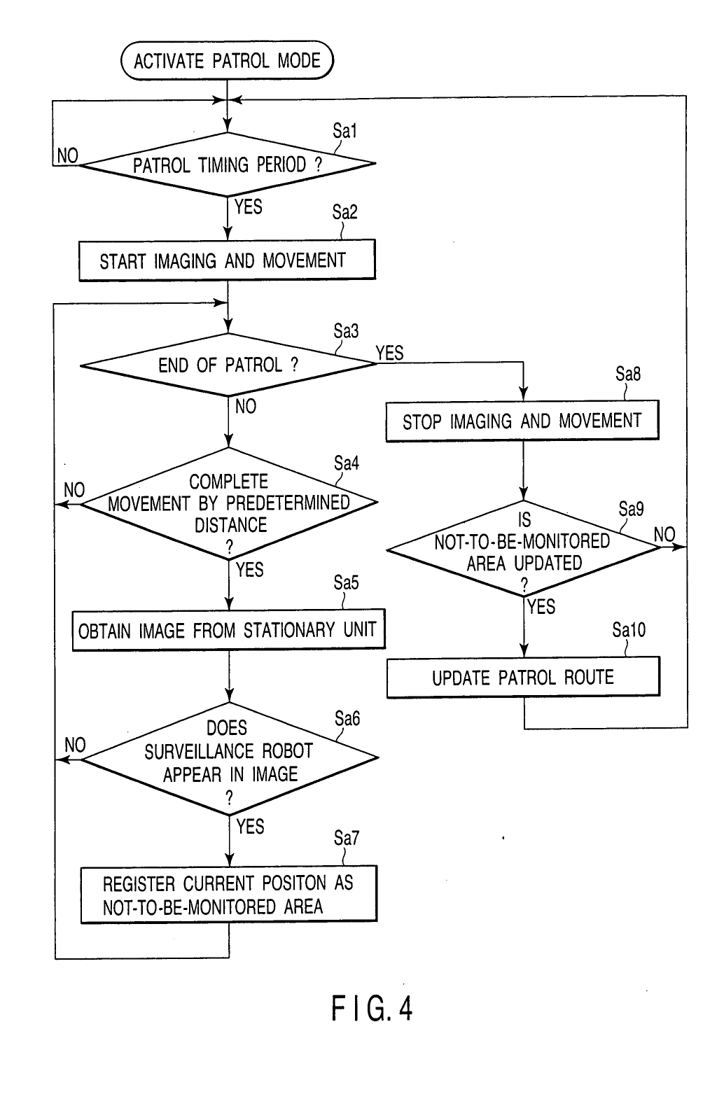

The surveillance robot 2 has operation modes that include a “patrol” mode. If the patrol mode is set by a user operation through a user interface (not shown), the overall control unit 2j of FIG. 1 executes a process as illustrated in FIG. 4.

Referring now to FIG. 4, in block Sa1, the overall control unit 2j stands by and commences imaging and/or movement upon an occurrence of a patrol timing event which commences a patrol timing period. The timing for patrolling may freely be set. For example, the patrol timing period may be set at predetermined time intervals, or the patrol timing period may be set to coincide with the patrol timing event (e.g., timing of issuance of an instruction for patrol by a remote-control operation via a communication network). It is also possible to set the patrol timing event to be continuous and provide continuous patrol-surveillance. Upon detecting the patrol timing event, the overall control unit 2j advances from block Sa1 to block Sa2.

In block Sa2, the overall control unit 2j instructs the camera unit 2a to start imaging (i.e., capture of images), and instructs the movement control unit 2i to start movement according to a predetermined patrol route. The patrol route is initially registered when the surveillance system is placed in the facility. The patrol route can freely be planned. It is contemplated, however, that the patrol route is selected so that the camera unit 2a can image all the range for surveillance within the monitored facility. If the start of movement is instructed by the overall control unit 2j, the movement control unit 2i activates the movement mechanism unit 2g so that the surveillance robot 2 may move according to the patrol route. Thus, the surveillance robot 2, while moving autonomously within the facility, requires images of different conditions in the facility. An image acquired by the camera unit 2a is processed by the image process unit 2b and the processed image is accumulated in the image accumulation unit 2d. The image process unit 2b may execute a process for detecting abnormalities such as the entrance of a suspicious person or the occurrence of a fire.

In this state, in block Sa3 and block Sa4, the overall control unit 2j stands by until the surveillance robot 2 completes movement along the patrol route, or until the surveillance robot 2 completes movement by a predetermined distance. The predetermined distance, in this context, is a given distance that is sufficiently smaller than the distance of the patrol route. If the surveillance robot 2 has moved by the predetermined distance, the overall control unit 2j advances from block Sa4 to block Sa5.

In block Sa5, the overall control unit 2j acquires an image, which is taken by the camera unit 1a, from the stationary unit 1 via the communication section 2c. In block Sa6, the overall control unit 2j confirms whether the surveillance robot 2 appears in the acquired image. In this case, if it is checked whether the red light 2r appears in the acquired image, it is possible to confirm, with a relatively simple process, whether the surveillance robot 2 appears in the acquired image. If the surveillance robot 2 appears in the acquired image, the overall control unit 2j advances from block Sa6 to block Sa7. In block Sa7, the overall control unit 2j registers the current position of the surveillance robot 2 as an area that requires no monitoring (hereinafter referred to as “not-to-be-monitored area”).

In the example shown in FIG. 2, a hatched area in the child's room is the effective imaging range of the camera unit 1a of the stationary unit 1. If the surveillance robot 2 moves into this range, the image acquired by the camera unit 1a shows the surveillance robot 2, as in FIG. 5. Thus, by registering the current position of the surveillance robot 2 when detected in the hatching area shown in FIG. 2, the not-to-be-monitored area can be mapped out.

Then, the overall control unit 2j returns to the standby state in block Sa3 and block Sa4. If the surveillance robot 2 does not appear in the acquired image in block Sa5, the overall control unit 2j does not advance to block Sa7, and returns from block Sa6 to the standby state in block Sa3 and block Sa4.

The above-mentioned predetermined distance is sufficiently less than the distance of the patrol route. Thus, it is determined twice or more in block Sa4 that the surveillance robot 2 has moved by the predetermined distance, before it is determined in block Sa3 that the surveillance robot 2 has completed movement along the patrol route. Each time the surveillance robot 2 moves by the predetermined distance, the overall control unit 2j checks whether the position of the surveillance robot 2 is within the effective imaging range of the camera unit 1a. If the position of the surveillance robot 2 is within the effective imaging range of the camera unit 1a, this position is registered as part of the not-to-be-monitored area for the surveillance robot 2.

If the surveillance robot 2 has completed movement along the patrol route, the overall control unit 2j advances from block Sa3 to block Sa8. In block Sa8, the overall control unit 2j instructs the camera unit 2a to stop imaging, and instructs the movement control unit 2i to stop movement. In a subsequent block Sa9, the overall control unit 2j confirms whether the not-to-be-monitored area is updated during the latest patrol. If the not-to-be-monitored area is updated, the overall control unit 2j advances from block Sa9 to block Sa10. In block Sa10, the overall control unit 2j updates the patrol route such that the not-to-be-monitored area is excluded from the imaging range of the surveillance robot 2.

Then, the overall control unit 2j returns to the standby state in block Sa1. If the not-to-be-monitored area is not updated, the overall control unit 2j does not advance to block Sa10 and returns to the standby state in block Sa1.

When the next patrol timing has come, the movement control unit 2i moves the surveillance robot 2 according to the updated patrol route. Thus, the surveillance robot 2 patrols so that the camera unit 2a may not image the range that is to be imaged by the camera unit 1a.

In this manner, the surveillance robot 2 learns the effective imaging range of the stationary unit 1, and executes imaging in a sharing fashion. That is, the stationary unit 1 images its own imaging range, and the surveillance robot 2 images the other to-be-monitored ranges. As a result, movement of the surveillance robot 2 is restricted within a minimum imaging range, thereby enhancing the efficiency of the surveillance.

In the meantime, while the patrol mode is being set, the overall control unit 2j gathers images that are acquired by the camera unit 1a, apart from the process illustrated in FIG. 4. Specifically, the overall control unit 2j acquires images from the stationary unit 1 at all times or at regular time intervals, and accumulates them in the image accumulation unit 2d.

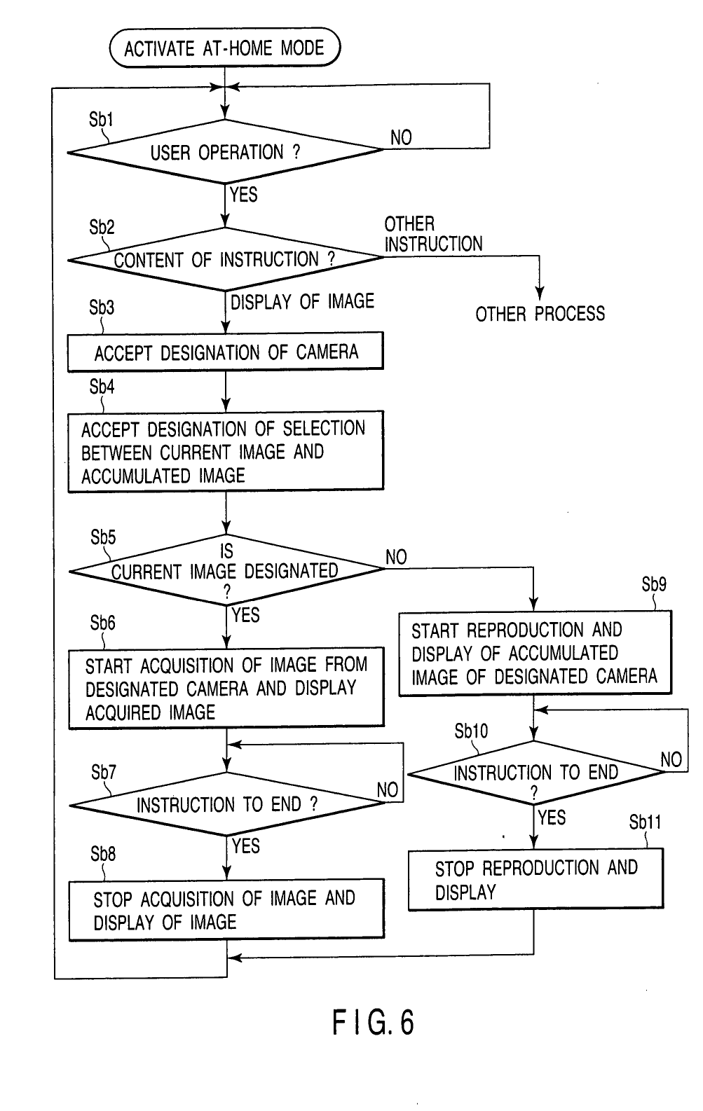

The surveillance robot 2 has another mode, “at-home mode.” If the “at-home mode” is set by a user operation through the user interface, the overall control unit 2j executes a process as illustrated in FIG. 6.

Referring now to FIG. 6, in block Sb1, the overall control unit 2j stands by for execution of a user operation through the user interface. If the user operation is executed, the overall control unit 2j advances from block Sb1 to block Sb2. In block Sb2, the overall control unit 2j confirms the content of the instruction that is input by the user operation. If the content of the instruction is associated with image display, the overall control unit 2j advances from block Sb2 to block Sb3.

In block Sb3, the overall control unit 2j accepts designation of the camera by the user operation through the user interface. In the first embodiment, there are provided two cameras, camera unit 1a and camera unit 2a. The overall control unit 2j accepts designation of the camera to be selected. In block Sb4, the overall control unit 2j accepts designation of an image that is selected between the current image and the accumulated image. This designation of selection is executed by the user operation through the user interface.

In block Sb5, the overall control unit 2j confirms whether the current image is selected. If the current image is selected, the overall control unit 2j advances from block Sb5 to block Sb6. If the accumulated image is selected, the overall control unit 2j advances from block Sb5 to block Sb9.

In block Sb6, the overall control unit 2j starts acquisition of the image that is taken by the designated camera, and causes the display unit 2e to display the acquired image. In block Sb7, the overall control unit 2j stands by for an instruction to end the acquisition and display of captured images. If the “end instruction” is issued by the user operation through the user interface, the overall control unit 2j advances from block Sb7 to block Sb8, and ends the acquisition and display of the image. Then, the overall control unit 2j returns to the standby state in block Sb1.

On the other hand, in block Sb9, the overall control unit 2j starts playback (also referred to as “reproduction”) and display of the image that is obtained by the designated camera and accumulated in the image accumulation unit 2d. The display unit 2e displays the reproduced image. In block Sb10, the overall control unit 2j stands by for an end instruction. If the “end” instruction is executed by a user operation through the user interface, the overall control unit 2j advances from block Sb10 to block Sb11, and ends the playback and display of the image. Then, the overall control unit 2j returns to the standby state in block Sb1.

In this way, the surveillance robot 2 can display on the display unit 2e the image that is currently acquired by the camera unit 2a and the image that was previously acquired by the camera 2a. Further, the surveillance robot 2 can display on the display unit 2e the image that is currently acquired by the camera unit 1a and the image that was previously acquired by the camera 1a. Therefore, the user can confirm all the images that are acquired by the camera unit 1a and camera unit 2a in a sharing fashion, by viewing the display unit 2e of the surveillance robot 2.

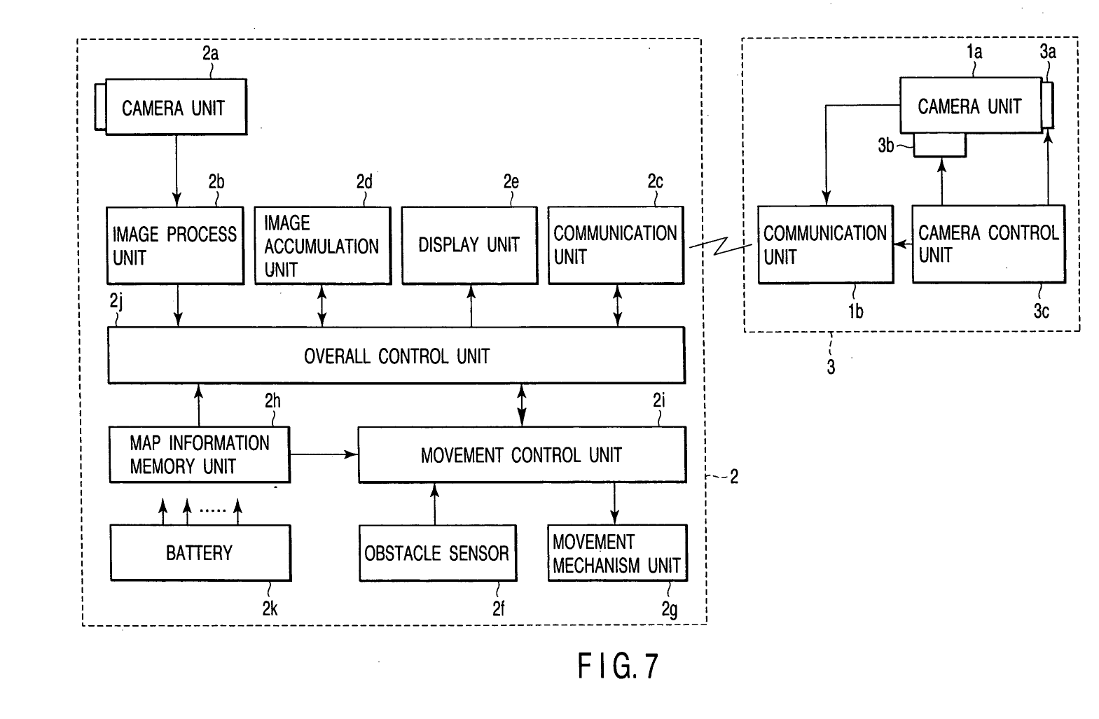

FIG. 7 is a block diagram showing the configuration of a surveillance system according to a second embodiment of the present invention. The parts common to those in FIG. 1 are denoted by identical reference numerals, and a detailed description is omitted.

As is shown in FIG. 7, the surveillance system according to the second embodiment includes a surveillance robot 2 and a stationary unit 3. The surveillance system of the second embodiment includes the stationary unit 3 in lieu of the stationary unit 1 in the first embodiment. The surveillance robot 2 of the second embodiment has the same structure as that of the first embodiment, but the processing in the overall control unit 2j is different, as will be described later.

The stationary unit 3 includes a camera unit 1a, a communication unit 1b, a zoom mechanism 3a, a camera platform 3b and a camera control unit 3c.

The zoom mechanism 3a alters the viewing angle of the camera unit 1a. The camera platform 3b pans and tilts the camera unit 1a. The camera control unit 3c controls the zoom mechanism 3a and camera platform 3b. The camera control unit 3c transmits camera information, which is indicative of the viewing angle and the direction of imaging by the camera unit 1a, to the surveillance robot 2 via the communication unit 1b.

The operation of the surveillance system according to the second embodiment with the above-described structure is described.

The camera control unit 3c controls the zoom mechanism 3a and camera platform 3b in accordance with a user operation through a user interface (not shown), thereby altering the viewing angle and the direction of imaging of the camera unit 1a.

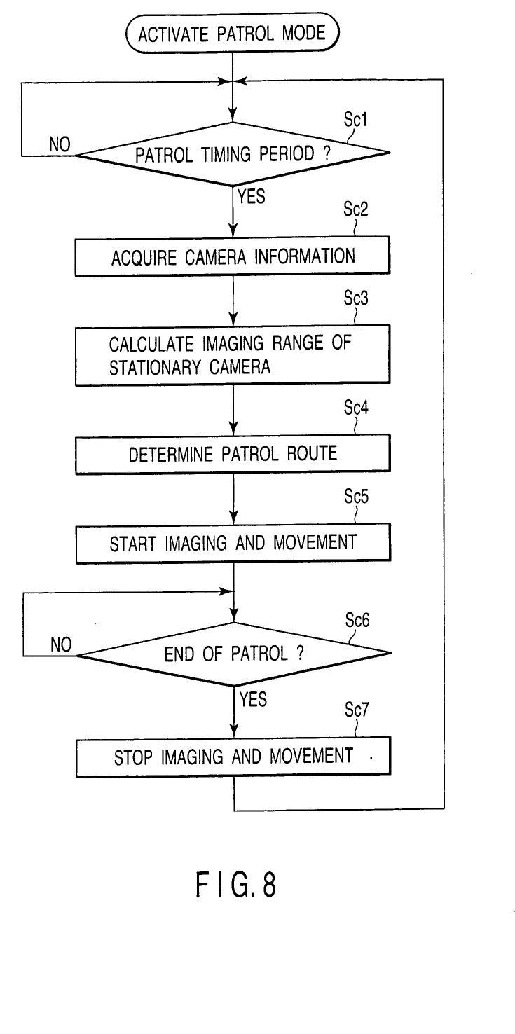

If the surveillance robot 2 is set in the patrol mode, the overall control unit 2j executes a process illustrated in FIG. 8.

In block Sc1, the overall control unit 2j stands by for the detection of the patrol timing event, as in the first embodiment. If the patrol timing event occurs, the overall control unit 2j advances from block Sc1 to block Sc2.

In block Sc2, the overall control unit 2j acquires camera information from the camera control unit 3c. In block Sc3, the overall control unit 2j calculates an effective imaging range of the camera unit 1a on the basis of the acquired camera information. In block Sc4, the overall control unit 2j determines a patrol route such that the camera unit 2a can image a range that is calculated by subtracting the effective imaging range of the camera unit 1a from the entire to-be-monitored range in the monitored facility.

Subsequently, in block Sc5, the overall control unit 2j instructs the camera unit 2a to start imaging, and instructs the movement control unit 2i to start movement according to the determined patrol route. In block Sc6, the overall control unit 2j stands by until the surveillance robot 2 completes the patrol along the patrol route. If the patrol is completed, the overall control unit 2j instructs, in block Sc7, the camera unit 2a to stop imaging, and also instructs the movement control unit 2i to stop movement. Thus, the overall control unit 2j returns to the standby state in block Sc1.

As has been described above, according to the second embodiment, the viewing angle and the direction of imaging of the camera unit 1a can be altered by the zoom mechanism 3a and camera platform 3b. The surveillance robot 2 calculates the effective imaging range of the camera unit 1a on the basis of the viewing angle and the direction of imaging of the camera unit 1a at the time of start of the patrol. The stationary unit 3 acquires image within this calculated imaging range, while the surveillance robot 2 acquires images within an area other than the area monitored by the camera unit 1a. As a result, the surveillance robot 2 moves within a minimum range, and the efficiency of surveillance is enhanced.

The configuration of the first or second embodiment is directly applicable to the configuration of a surveillance system according to a third embodiment of the invention. The third embodiment differs from the first or second embodiment only with respect to the content of processing in the overall control unit 2j.

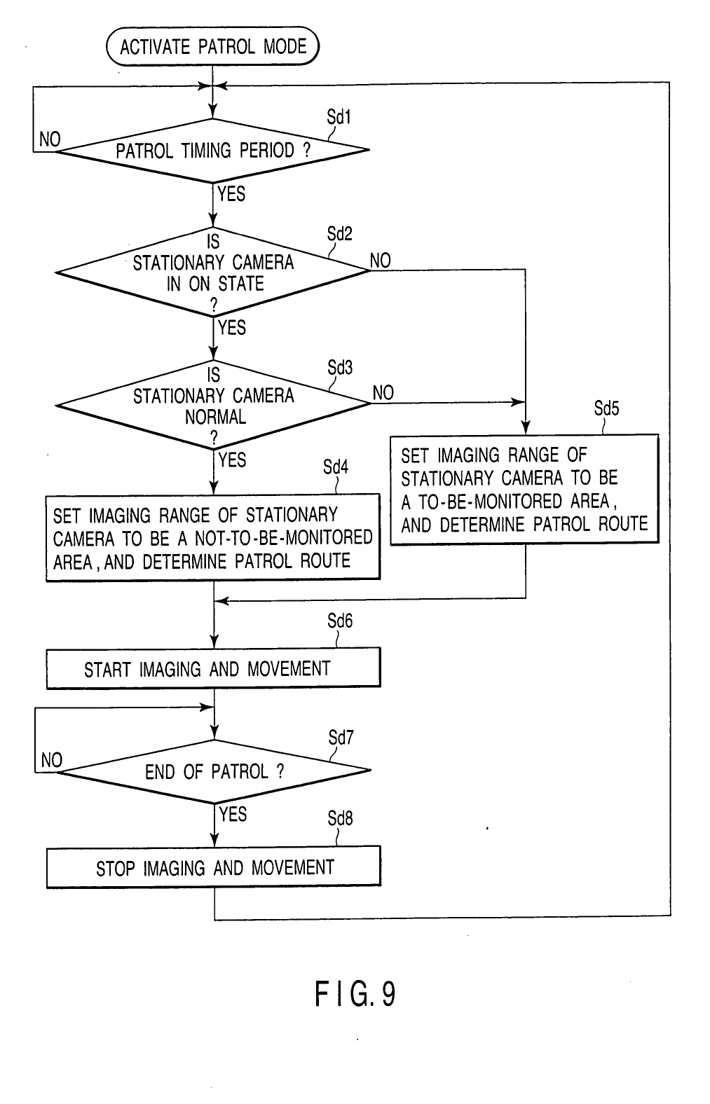

If the surveillance robot 2 is set in the patrol mode, the overall control unit 2j executes a process illustrated in FIG. 9.

In block Sd1, the overall control unit 2j stands by for the start of the patrol timing period, as in the first embodiment. If the patrol timing period has started, the overall control unit 2j advances from block Sd1 to block Sd2.

In block Sd2 and block Sd3, the overall control unit 2j confirms whether the operation of the camera unit 1 is set in an ON state and the operation of the camera unit 1a is normal. If this condition is satisfied, the overall control unit 2j advances from block Sd3 to block Sd4. If the condition is not satisfied, the overall control unit 2j advances from block Sd2 or block Sd3 to block Sd5.

In block Sd4, the overall control unit 2j sets the effective imaging range of the camera unit 1a to be a not-to-be-monitored area for the surveillance robot 2, and thus determines a patrol route. On the other hand, in block Sd5, the overall control unit 2j sets the imaging range, which is assigned to the camera unit 1a, to be a “to-be-monitored” area for the surveillance robot 2, and thus determines a patrol route.

In short, if the operation of the camera unit 1a is in the ON state and the operation of the camera unit 1a is normal, the assigned imaging range of the camera unit 1a is deemed to be within the effective imaging range of the camera unit 1a, and thus, this area is set as a part of the not-to-be-monitored area for the surveillance robot 2. On the other hand, if the operation of the camera unit 1a is in the OFF state or if the operation of the camera unit 1a is not normal, the assigned imaging range of the camera unit 1a is deemed to be a non-effective imaging range. Thus, the imaging range of the camera unit 1a is set to be within also the “to-be-monitored” area for the surveillance robot 2. The assigned imaging range of the camera unit 1a may be set in advance by a person, or it may be set by the automatic determination as described in the first embodiment or the second embodiment.

Subsequently, in block Sd6, the overall control unit 2j instructs the camera unit 2a to start imaging, and instructs the movement control unit 2i to start movement according to the patrol route that is determined in block Sd4 or block Sd5. In block Sd7, the overall control unit 2j then stands by until the surveillance robot 2 completes the patrol along the patrol route. If the patrol is completed, the overall control unit 2j instructs, in block Sd8, the camera unit 2a to stop imaging, and also instructs the movement control unit 2i to stop movement. Thus, the overall control unit 2j returns to the standby state in block Sd1.

As has been described above, according to the third embodiment, if the operation of the camera unit 1a is in the ON state and the operation of the camera unit 1a is normal, a control is executed to cause the stationary unit 1, 3 to image the assigned imaging range of the camera unit 1a, and to cause the surveillance robot 2 to image the other imaging range in a sharing fashion. As a result, the surveillance robot 2 moves within a minimum range, and the efficiency of surveillance is enhanced. However, if the operation of the camera unit 1a is in the OFF state or if the operation of the camera unit 1a is not normal, the assigned imaging range of the camera unit 1a is non-effective and not available for the stationary unit 1, 3. Thus, the surveillance robot 2 is controlled to image the entirety of the “to-be-monitored” area in the facility. Hence, the to-be-monitored range can exactly be imaged.

The present invention is not limited to the above-described embodiments. In each embodiment, a plurality of stationary units 1, 3 may be installed. In this case, the assigned range of each camera unit 1a may be determined with respect to the associated stationary unit 1, 3, and the entire imaging range may be set to be a not-to-be-monitored area for the surveillance robot 2.

In each embodiment, it is possible to freely set the timing for determining the imaging range of the camera unit 1a, or the timing for determining the patrol route.

In the third embodiment, it is possible to determine the effective imaging range of the camera unit 1a on the basis of only one of the two conditions: (1) whether the operation of the camera unit 1a is in the ON state, or (2) whether the operation of the camera unit 1a is normal.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A surveillance system comprising:
a stationary unit including a first camera unit; and
a surveillance robot that comprises
a second camera unit, and
means for controlling movement of the surveillance robot so that the second camera acquires images in an imaging range excluding an imaging range of the first camera unit.

2. The surveillance system according to claim 1, wherein the surveillance robot further comprises
means for obtaining an image that is acquired by the first camera unit, and
means for determining a position of the surveillance robot at a time when the surveillance robot appears in the imaging range of the first camera unit.

3. The surveillance system according to claim 1, wherein the stationary unit further comprises:
means for altering either a viewing angle or a direction of the first camera unit; and
means for determining the imaging range of the first camera unit in accordance with the viewing angle or the direction of the first camera unit.

4. The surveillance system according to claim 1 further comprising:
means for determining a predetermined range to be the imaging range when the first camera unit is normal; and
means for determining the imaging range to be a non-effective imaging range when the first camera unit is not normal.

5. The surveillance system according to claim 1, wherein the means for determining a predetermined range to be the imaging range when an imaging operation of the first camera unit is in an ON state, and means for determining the imaging range to be a non-effective imaging range when the imaging operation of the first camera unit is in an OFF state.

6. The surveillance system according to claim 4 or 5, wherein the surveillance robot further comprises:
means for obtaining an image that is acquired by the first camera unit; and
means for determining a position of the surveillance robot at a time when the surveillance robot appears in the image of the predetermined range.

7. The surveillance system according to claim 4 or 5, wherein the stationary unit further comprises means for altering a viewing angle or a direction of the first camera unit, and the surveillance robot further comprises means for determining the predetermined range in accordance with the viewing angle or the direction of the first camera unit.

8. The surveillance system according to claim 1, wherein the surveillance robot further comprises:
means for obtaining an image that is acquired by the first camera unit; and
means for displaying the image.

9. The surveillance system according to claim 1, wherein the surveillance robot further comprises:
means for obtaining an image that is acquired by the first camera unit;
means for accumulating the image; and
means for displaying the image that is accumulated.

10. A surveillance robot that constitutes, along with a stationary unit with a first camera unit, a surveillance system, comprising:
a second camera unit;
means for determining an imaging range of the first camera unit; and
means for moving the surveillance robot so that the second camera unit acquires images in a to-be-monitored range, excluding the imaging range of the first camera unit.

11. The surveillance robot according to claim 10, further comprising means for obtaining an image that is acquired by the first camera unit.

12. The surveillance robot according to claim 10, wherein the determination means determines the imaging range in accordance with an angle of view or a direction of the first camera unit.

13. The surveillance robot according to claim 10, wherein the means for determining the imaging range of the first camera unit determines a position of the surveillance robot at a time when the surveillance robot appears in the image acquired by the first camera unit.

14. A method comprising:
providing a surveillance system including a stationary unit and a surveillance robot; and
determining an imaging range of the surveillance robot by (i) detecting the surveillance robot being within an imaging range of the stationary unit, (ii) determining a location of the surveillance robot when detected to be within the imaging range of the stationary unit, and (iii) excluding the location from the imaging range of the surveillance robot.

15. The method according to claim 14 wherein the stationary unit comprises a first camera unit and a communication unit to communicate with the surveillance robot.

16. The method according to claim 15, wherein detecting the surveillance robot comprises receiving an image from the communication unit, identifying the surveillance robot being within the image, and registering a current position of the surveillance robot to be excluded from the imaging range of the surveillance robot.

17. The method according to claim 15, wherein detecting the surveillance robot comprises:
calculating an effective imaging range of the camera unit based on a viewing angle and direction of imaging of the first camera unit; and
subtracting an effective imaging range of the camera unit to compute an entire to-be-monitored range.
